(19) United States
(12) Patent Application Publication
(10) Pub. No.: US 2004/0024916 A1
(43) Pub. Date: Feb. 5, 2004

(54) Portable computer with shared expansion slot

(76) Inventor: Chien Hsing, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/064,600

(22) Filed: Jul. 30, 2002

(51) Int. Cl. G06F 3/00

(52) U.S. Cl. 710/1

(57) ABSTRACT

A portable computer includes a processor, a display device, an expansion slot with expansion card, and a communications module. The communications module having four modes that each restricts access in a different way to the expansion slot and corresponding expansion card resources by the processor and another computer. The mode of the communications module can be set by the communications module detecting states of a connection port and a wireless communications module of the portable computer. Alternatively, the mode of the communications module can be set by the processor and the other computer.

### BACKGROUND OF INVENTION

1. Field of the Invention

The present invention relates to a portable computer, and more specifically, to a portable computer having an expansion slot that can be directly accessed by another computer.

2. Description of the Prior Art

Being able to connect computers together to share resources is of benefit to computer users. As portable computers become increasingly popular, it is important for a user to be able to connect a portable computer with another computer to share information and resources.

Many prior art portable computers have expansion slots for adding expansion cards to increase capabilities. For instance, referring to FIG. 1, a portable computer 10 has an expansion slot 12 that accepts a flash memory card 14. When the flash memory card 14 is inserted into the expansion slot 12, the portable computer 10 can access the flash memory card 14 and in effect, the portable computer 10 has more memory. Besides the flash memory card 14, there are many other kinds of expansion cards that are readily available such as peripheral interface cards and network adaptors.

The prior art portable computer 10 can also be connected to another computer, such as desktop computer (item 32 of FIG. 2), through a connection port 16 or a wireless communications module (item 18 of FIG. 2). When the portable computer 10 is connected to the desktop computer 32, information can be exchanged between the portable computer 10 and the desktop computer 32.

Please refer to FIG. 2, which shows a block diagram of the prior art portable computer 10 connected to the desktop computer 32. The portable computer 10 further comprises the wireless communications module 18 for connecting to the computer 32 wirelessly, an input/output (I/O) interface 20, a processor 22, a memory 24, and a user interface 26. The user interface 26 includes a display device 28, such as a liquid crystal display (LCD), and an input device 30. The I/O interface 20 allows commands and data to be exchanged between the processor 22 and the expansion slot 12, the wireless communications module 18, and the connection port 16.

If resources of the expansion slot 12, and accordingly the flash memory card 14, are to be shared with the computer 32, the processor 22 must manage the exchange of information. Thus, the operating systems of the processor 22 and the computer 32 must be compatible. Additionally, the computer 32 is inherently limited in its access to the flash memory card 14 because of the processor managing the exchange of information.

A major drawback of the prior art portable computer 10 is that the expansion slot 12 and accordingly the flash memory card 14 cannot be directly accessed by the desktop computer 32. While the desktop computer 32 can indirectly access the information in the flash memory card 14 in a limited way through the processor 22, the desktop computer 32 cannot utilize the flash memory card 14 as its own memory. This is also the case for other expansion cards that can be put into the expansion slot 12 of the portable computer 10. Allowing direct access to the expansion card 14 by the desktop computer 32 is of importance in common situations such as when the portable computer 10 and desktop computer 32 have different operating systems.

Therefore, the prior art lacks a portable computer having an expansion port that can be directly accessed by another computer.

### SUMMARY OF INVENTION

It is therefore a primary objective of the claimed invention to provide a portable computer that has an expansion slot that can be directly accessed by another computer to solve the problems of the prior art.

Briefly summarized, the claimed invention includes a processor, a display device that displays output of the processor, a communications module that communicates with a computer, and an expansion slot that can accept an expansion card. When the communications module is in a first mode the communications module allows communication between the expansion slot and the processor and prevents communication between the expansion slot and the computer. When the communications module is in a second mode the communications module allows communication between the expansion slot and the computer and prevents communication between the expansion slot and the processor. Also provided are third and fourth modes that respectively prevents communication between the expansion slot and the processor or the computer, and allows communication between the expansion slot and both the processor and computer.

According to the claimed invention, the claimed invention further includes a connection port and a wireless communications module. The mode of the communications module can be set by the communications module detecting states of the connection port, wireless communications module, and expansion slot. Alternatively, the mode of the communications module can be set by the processor and the computer.

It is an advantage of the claimed invention that the communications module has up to four modes and as a result provides direct access to the expansion card to both the portable computer and the computer.

It is a further advantage of the claimed invention that the resources of the expansion card can be used by both the portable computer and the computer.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a perspective view of a prior art portable computer and expansion card.

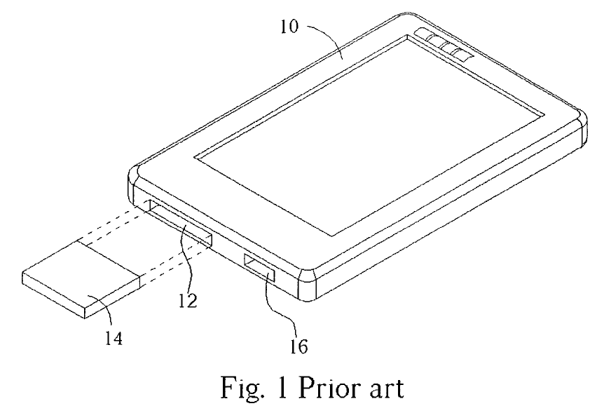

FIG. 2 is a block diagram of the portable computer of FIG. 1.

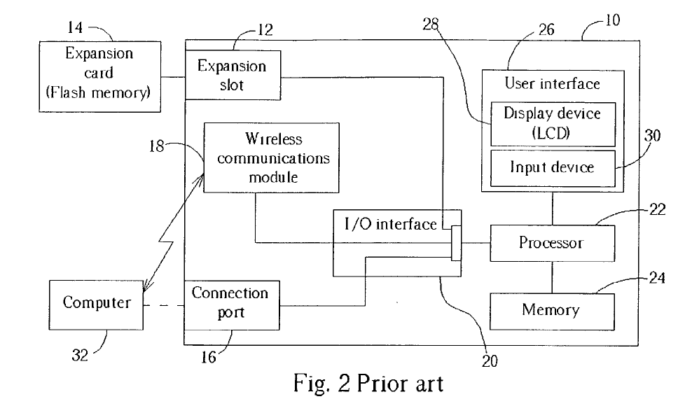

FIG. 3 is a block diagram of a portable computer according to the preferred embodiment of the present invention.

FIG. 4 is a block diagram of the communications module of FIG. 3 in a second mode.

FIG. 5 is a block diagram of a second embodiment of the communications module shown in FIG. 3.

### DETAILED DESCRIPTION

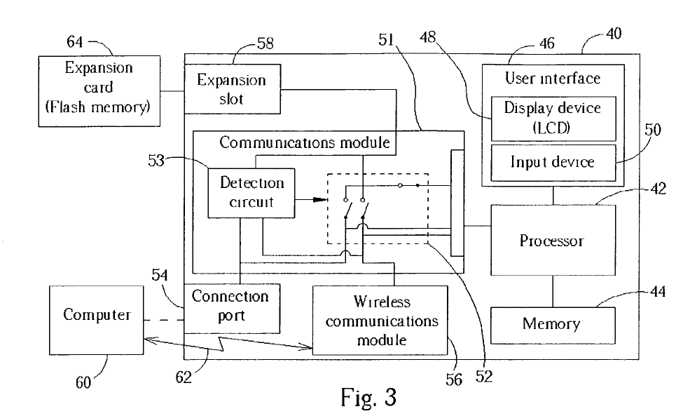

A portable computer 40 according to the preferred embodiment of the present invention is shown in FIG. 3. The portable computer 40 comprises a processor 42 and a memory 44 for providing functions such as controlling a user interface 46. The user interface includes a display device 48, commonly a liquid crystal display (LCD), and an input device 50, which can be any number of devices such as a touch screen component of the LCD 48, a keyboard, or a touch pad. Connected to the processor 42 is a communications module 51. The communications module 51 serves to manage the flow of data between the processor 42 and a connection port 54, a wireless communications module 56, and an expansion slot 58. The connection port 54 is used to connect the portable computer 40 with another computer 60 so that information can be exchanged. The wireless communications module 56 serves the same purpose as the connection port 54, except that the wireless communications module 56 communicates with the computer 60 using electromagnetic signals 62 according to a wireless local area network (LAN) standard such as that set by IEEE 802.11b. The expansion slot 58 can accept an expansion card 64, which delivers added functionality to the portable computer 40 such as additional flash memory, a peripheral interface, or a network interface. For the purposes of this detailed description the expansion slot 58 is a secure digital (SD) expansion slot, and the expansion card 64 is an SD flash memory card, but both should not be construed to be limited to such. Of course, the portable computer 40 comprises additional components, however, these will not be described here as it is well known in the art and is extraneous to the detailed description of the preferred embodiment.

The communications module 51 comprises a switch circuit 52 and a detection circuit 53. The switch circuit 52 shown in FIG. 3 is shown simplified for illustrative purposes. In practical application and as well known in the art, the switch circuit 52 can be realized by employing an integrated circuit (IC) I/O bus. Similarly, the detection circuit 53 is shown only schematically and can also be realized using an IC chip. Naturally, the switch circuit 52 and the detection circuit 53 can be combined into a single circuit that can be disposed on a single IC chip.

The detection circuit 53 detects states of the connection port 54, the wireless communications module 56, and the expansion slot 58 and controls the switch circuit 52 accordingly. For instance, the detection circuit 53 as shown in FIG. 3 has detected that the connection port 54 is not connected to the computer 60 and that the wireless communications module 56 is active. This is interpreted as the portable computer 40 being used in a portable manner, that is, disconnected from the computer 60. Accordingly, the detection circuit 53 controls the switch circuit 52 to connect the expansion slot 58 to the processor 42 and connect both the connection port 54 and the wireless communications module 56 to the processor 42. Hence, potential communication between the connection port 54 or wireless communications module 56 and the expansion slot 58 is regulated by the processor 42. For that reason, the computer 60 cannot directly access or issue commands to the expansion slot 58, and in effect, the resources of the flash memory card 64 are controlled by the processor 42. This first mode of the communications module 51 allows the processor 42 to control the resources of the expansion card 64.

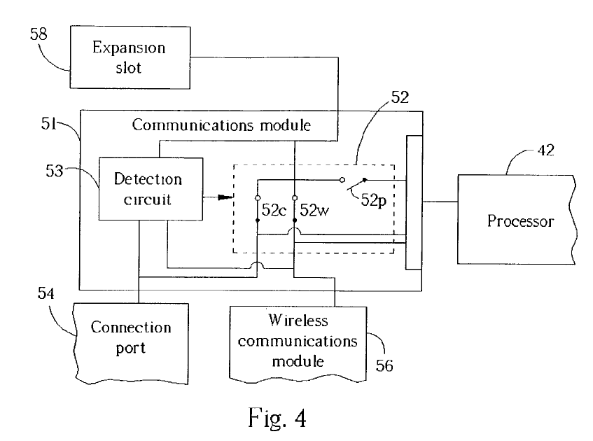

A second mode of the communications module 51 is shown in FIG. 4. Also shown in FIG. 4 are switches 52c, 52w, and 52p of the switch circuit 52. In the second mode, the detection circuit 53 has detected that the connection port 54 is connected to the computer 60 and that the wireless communications module 56 is not active. This is interpreted as the portable computer 40 being used in combination with the computer 60, and connected to the computer 60 through a cradle or similar apparatus. Accordingly, the detection circuit 53 controls the switch circuit 52 to set switch 52p so that expansion slot 58 is disconnected from processor 42 and set switches 52c and 52w so that both the connection port 54 and the wireless communications module are connected to the expansion slot 58. Consequently, there is direct communication by both the connection port 54 and wireless communications module 56 with the expansion slot 58. As a result, the computer 60 can directly access and issue commands to the expansion slot 58, and in effect, the resources of the flash memory card 64 are controlled by the computer 60.

A third mode is defined as setting the switches 52c, 52w, and 52p as open to disconnect all of the processor 42, the connection port 54, and the wireless communications module 56 from the expansion slot 58. This is can be used if the flash memory card 64 is removed from the expansion slot 58. The third mode is entered when the communications module 51 detects that the expansion slot 58 is empty.

Referring to FIG. 3, a user wants to utilize the portable computer 40 wirelessly, that is, not connected to the computer 60. To do this, the user disconnects the connection port 54 from the computer 60. The detection circuit 53 detects that the connection port 54 is inactive and controls the switch circuit to connect the expansion port 58 to only the processor 42. At this time, the user can still access the computer 60 through the wireless communication module 56. However, the resources of the flash memory card 64 are controlled by the processor 52.

When the user wishes to utilize the portable computer 40 connected to the computer 60, the user connects the connection port 54 to the computer 60 via a cradle, cable, or similar connection apparatus. The detection circuit 53 detects that the connection port 54 is active and controls the switch circuit 52 to set the switches 52c, 52w, and 52p as shown in FIG. 4. The portable computer 40 now allows direct access to the expansion slot 58 and the resources of the flash memory card 64 by the computer 60 and prevents direct access to the flash memory card 64 by the processor 42. In other words, the user can use the computer 60 to directly access the flash memory card 64.

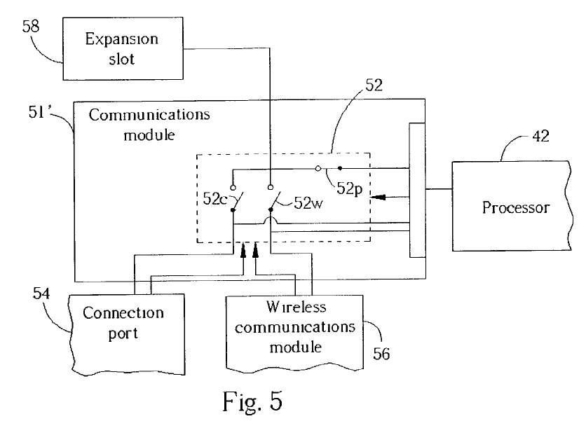

Consider a second embodiment of the communications module 51″ as illustrated in FIG. 5. The communications module 51″ comprises the switch circuit 52, but does not include a detection circuit. Rather, the processor 42, the connection port 54, and the wireless communications module 56 control the setting of the switches 52c, 52w, and 52p of the switch circuit 52. The switches 52c, 52w, and 52p can be set to give the communications module 51″ all three of the previously described modes, namely the first mode, the second mode, and the third mode.

In the second embodiment, the communications module 51″ accepts commands from the processor 42, the connection port 54, and the wireless communications module 56 and changes modes accordingly. Hence, the computer 60 and the processor 42 must cooperate to determine how the resources of the flash memory card 64 are to be accessed. The processor 42 and the computer 60 have shared direct control over the resources of the flash memory card 64. In fact, the resources of the flash memory card 64 are more tightly controlled in the second embodiment. While the second embodiment is less automatic than the preferred embodiment, the desired result is still achieved.

A fourth mode of the communications module 51 is also provided for by the second embodiment. In the fourth mode, the switches 52c, 52w, and 52p are all set to closed so that both the computer 60 and the processor 42 have direct access to the expansion slot 58. In the fourth mode, the resources of the flash memory card 64 are available to both the computer 60 and the processor 42. Negotiation for and distribution of the resources of the flash memory card 64 are performed by both the computer 60 and the processor 42. As mentioned previously, the switches 52c, 52w, and 52p are in practical application IC circuits and are shown as simplified single-input-single-output switches for explanatory purposes only.

Naturally, other combinations of the settings of the switches 52c, 52w, and 52p and corresponding modes of the switch circuit 52 are possible. These additional modes of the switch circuit 52 are inherent to the design of the switch circuit 52 and do not add any unexpected functionality over the four modes already described.

For both the preferred and second embodiments, the connection port 54 can be redundant, and the wireless communications module 56 can be the only means for communicating with the computer 60, the state of wireless communications module 56 being detected by the communications module 51 in the preferred embodiment. Likewise, the present invention portable computer 40 need not comprise the wireless communications module 56, the state of the connection port 54 being detected by the communications module 51 in the preferred embodiment as described.

Other embodiments, such as an embodiment allowing the switch circuit 52 to be controlled by both the detection circuit 53 and the processor 42, are also possible by applying the teachings of the present invention.

In contrast to the prior art, the present invention communications module allows direct access to an expansion slot and corresponding expansion card by both a processor of a portable computer and another computer. The present invention also provides modes of the communications module that can be either automatically switched or controlled. Thus, the resources of the expansion card can be used by both the portable computer and the other computer.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A portable computer that is capable of being connected to a computer, the portable computer comprising:
a processor;
a display device electrically connected to the processor for displaying output of the processor;
a communications module electrically connected to the processor for communicating with the computer, the communications module having a first mode and a second mode; and
an expansion slot electrically connected to the processor capable of accepting an expansion card for expanding capabilities of the processor;
wherein when the communications module is in the first mode the communications module allows communication between the expansion slot and the processor and prevents communication between the expansion slot and the computer, and when the communications module is in the second mode the communications module allows communication between the expansion slot and the computer and prevents communication between the expansion slot and the processor.

2. The portable computer of claim 1 wherein the communications module further comprises a third mode, wherein the communications module in the third mode prevents communication between the expansion slot and the processor, and prevents communication between the expansion slot and the computer.

3. The portable computer of claim 2 wherein the communications module is in the third mode when the expansion card is removed from the expansion slot.

4. The portable computer of claim 1 further comprising a connection port electrically connected to the communications module, wherein the connection port is capable of being connected to the computer.

5. The portable computer of claim 4 wherein the mode of the communications module is set by the communications module detecting a state of the connection port of the portable computer, wherein the communications module is in the first mode when the connection port is not connected to the computer, and the communications module is in the second mode when the connection port is connected to the computer.

6. The portable computer of claim 1 further comprising a wireless communications module electrically connected to the communications module, wherein the wireless communications module is capable of exchanging signals with the computer.

7. The portable computer of claim 6 wherein the mode of the communications module is set by the communications module detecting a state of the wireless communications module, wherein the communications module is in the first mode when the wireless communications module is not exchanging signals with the computer, and the communications module is in the second mode when the wireless communications module is exchanging signals with the computer.

8. The portable computer of claim 6 wherein the mode of the communications module is set by the communications module detecting a state of the wireless communications module, wherein the communications module is in the first mode when the wireless communications module is exchanging signals with the computer, and the communications module is in the second mode when the wireless communications module is not exchanging signals with the computer.

9. The portable computer of claim 1 wherein the mode of the communications module is set by the processor and the computer.

10. The portable computer of claim 9 wherein the communications module further comprises a fourth mode, wherein the communications module allows the expansion slot to communicate with both the processor and the computer.

11. The portable computer of claim 1 further comprising a connection port electrically connected to the communications module, wherein the connection port is capable of being connected to the computer.

12. The portable computer of claim 1 further comprising a wireless communications module electrically connected to the communications module, wherein the wireless communications module is capable of exchanging signals with the computer.

13. The portable computer of claim 1 further comprising an input device for interfacing with the portable computer.

14. The portable computer of claim 1 wherein the expansion card is a secure digital (SD) card.

15. The portable computer of claim 1 wherein the expansion card is a flash memory card.

16. The portable computer of claim 1 wherein the display device is a liquid crystal display (LCD).
